(19) United States
(12) Patent Application Publication
(10) Pub. No.: US 2011/0019722 A1
(43) Pub. Date: Jan. 27, 2011

(54) Per-Tone Delay Adjustment for Multi-Tone Systems

(76) Inventor: Amir Amirkhany, Sunnyvale, CA (US)

Correspondence Address: MORGAN LEWIS & BOCKIUS LLP/RAMBUS INC., 2 PALO ALTO SQUARE, 3000 EL CAMINO REAL, SUITE 700, PALO ALTO, CA, 94306, US

(21) Appl. No.: 12/837,656

(22) Filed: Jul. 16, 2010

Related U.S. Application Data
(60) Provisional application No. 61/228,942, filed on Jul. 27, 2009.

(51) Int. Cl. H04L 5/16; H04L 27/00

(52) U.S. Cl. 375/219; 375/295

(57) ABSTRACT

A data transmission circuit has an interface for receiving a data stream for transmission, a data stream splitter, a plurality of parallel data preparation circuits, and a combiner. The data stream splitter splits the data stream to produce multiple substreams, the plurality of parallel data preparation circuits prepare a respective substream for transmission and generate a respective sub-channel signal, and the combiner combines the respective sub-channel signals to generate a data transmission signal. At least two of the plurality of data preparation circuits each include a programmable element for delaying the corresponding substream.

### RELATED APPLICATION

This application claims priority to U.S. Provisional Application Ser. No. 61/228,942, filed Jul. 27, 2009, entitled “Per-Tone Delay Adjustment for Multi-Tone Systems,” which is incorporated herein by reference in its entirety.

### TECHNICAL FIELD

The subject matter disclosed herein relates generally to the communication of data. More specifically, the subject matter relates to circuits and associated methods and systems for adjusting sub-channel delay in a transmitter of a multi-tone system.

### BACKGROUND

A multi-tone system concurrently transmits parallel signals on multiple sub-channels of one physical channel. Individual sub-channels are differentiated by their carrier frequency or frequency band. Channel response, particularly latency, is different for each of the parallel sub-channels. The difference in sub-channel latencies becomes more significant, in terms of its impact on a receiver's ability to receive the transmitted data, as the rate of data transmission over the sub-channels increases.

### BRIEF DESCRIPTION OF THE DRAWINGS

FIG. 1 illustrates an exemplary timing relationship of a data stream in a multi-tone system without adjustment.

FIG. 2A is a block diagram illustrating a data transmitting device and a calibration circuit in accordance with some embodiments.

FIG. 2B is a block diagram illustrating a data preparation circuit in accordance with some embodiments.

FIG. 2C is a block diagram illustrating a data preparation circuit in accordance with some embodiments.

FIGS. 2D-F are block diagrams illustrating calibration circuits in accordance with some embodiments.

FIGS. 3A-B are flow diagrams of a process for transmitting data in accordance with some embodiments.

FIG. 4 is a flow diagram of a process for a transmitting data in accordance with some embodiments.

FIG. 5 is a block diagram of an embodiment of a system for storing computer readable files containing software descriptions of circuits for implementing a data transmission circuit in accordance with some embodiments.

Like reference numerals refer to corresponding parts throughout the drawings.

### DESCRIPTION OF EMBODIMENTS

As noted above, channel response, particularly latency, is different for each of the parallel sub-channels of a multi-tone data transmission system. The difference in sub-channel latencies becomes more significant, in terms of its impact on a receiving device's ability to accurately receive the transmitted data, as the rate of data transmission over the sub-channels increases. This is because the same latency differential becomes, at higher data rates, a larger portion of the timing margin (sometimes called the data eye) at the receiving device. In the embodiments described below, the differences in sub-channel latencies are compensated so that signals transmitted simultaneously on all sub-channels arrive at the substantially same time at the receiver. More precisely, the differences in sub-channel latencies are at least partially compensated so that the maximum (i.e., worst case) difference in latency between any two of the sub-channels is significantly reduced, which enables interference-free detection of the transmitted data.

In a multi-tone system, the sub-channels are preferably mutually orthogonal, or substantially orthogonal, to avoid or minimize inter-channel interference. Latency differentials between sub-channels, however, reduces the orthogonality of the sub-channels, which results in increased inter-channel interference. By equalizing or compensating the latency differentials of the signals transmitted on the parallel sub-channels, the orthogonality of the transmitted signals (on the sub-channels) upon arrival at the receiving device can be substantially restored.

A data transmission circuit has an interface for receiving a data stream for transmission, a data stream splitter, a plurality of parallel data preparation circuits, and a combiner. The data stream splitter splits the data stream to produce multiple substreams. The plurality of parallel data preparation circuits prepare a respective substream for transmission and generate a respective sub-channel signal. At least two of the plurality of data preparation circuits each include a programmable element for delaying the corresponding substream. The combiner combines the respective sub-channel signals to generate a data transmission signal.

In some embodiments, each programmable element receives a distinct delay value. In some embodiments, at least two of the plurality of programmable elements each receive a first delay value and at least one other of the plurality of programmable elements receives a second delay value (distinct from the first delay value).

In some embodiments, each data preparation circuit includes a modulator. In some embodiments, each data preparation circuit includes a digital to analog conversion circuit.

In some embodiments, the data transmission circuit includes calibration circuitry to calibrate the plurality of data preparation circuits. In some embodiments, the calibration circuitry includes pattern storage, match circuitry, and delay calibration logic. Pattern storage stores a plurality of calibration patterns and sends a respective calibration pattern to the data stream splitter. Match circuitry receives a return data stream corresponding to the transmission signal and compares the return data stream to the respective calibration pattern to produce a match result. Delay calibration logic determines a delay value. In some embodiments, each of the plurality of data preparation circuits is calibrated individually.

In some embodiments, each programmable element comprises a programmable filter circuit.

A method of transmitting data includes receiving a data stream for transmission, splitting the data stream to produce multiple substreams, preparing a respective substream for transmission, generating a respective sub-channel signal, and combining the respective sub-channel signals to generate a data transmission signal. Preparing a respective substream includes delaying the corresponding substreams relative to another one of the multiple substreams by a delay value.

In some embodiments, the method includes converting a respective substream from a digital signal to an analog signal.

In some embodiments, the method includes performing a calibration operation to determine the delay value for at least one of the respective substreams. In some embodiments, the calibration operation includes storing a plurality of calibration patterns, sending a respective calibration pattern to the data stream splitter, receiving a return data stream corresponding to the transmission signal, comparing the return data stream to the respective calibration patterns to produce a match result, and determining the delay value based on the match result. In some embodiments, the calibration operation includes determining the delay value for each substream individually.

A data communication system has a communications channel, a data transmission circuit, and a data receiving circuit. The data transmission circuit is coupled to a first end of the communications channel and the data receiving circuit is coupled to a second end of the communications channel. The data transmission circuit outputs a data transmission signal onto the communications channel. The data transmission signal carries at least two parallel data streams and is a combination of at least two data signals, each data signal carrying a different one of the at least two parallel data streams using a different frequency band. The at least two data signals are offset in phase at the first end of the communications channel and substantially aligned in phase at a second end of the communications channel. The data receiving circuit extracts each of the at least two parallel data streams from the data transmission signal.

A method of transmitting data includes transmitting a data transmission signal, which carries at least two parallel data streams, onto a communications channel. The data transmission signal is a combination of at least two data signals, each data signal carrying a different one of the at least two parallel data streams using a different frequency band. The at least two data signals are offset in phase at a first end of the communications channel according to at least one delay value. The method further includes selecting the at least one delay value such that the at least two data signals are substantially aligned in phase at a second end of the communications channel and extracting each of the at least two parallel data streams from the second end of the communications channel.

A multi-tone device has at least one data pin coupled to a first end of a communications channel and a data transmission circuit coupled to the at least one data pin. The data transmission circuit outputs a data transmission signal. The data transmission signal carries at least two parallel data streams onto the communications channel and is a combination of at least two data signals. Each of the two data signals carry a different one of the at least two parallel data streams using a different frequency band, and are offset in phase at the first end of the communications channel according to at least one delay value. The at least one delay value is selected such that the at least two data signals are substantially aligned in phase at a second end of the communications channel.

Reference will now be made in detail to embodiments, examples of which are illustrated in the accompanying drawings. In the following detailed description, numerous specific details are set forth in order to provide a thorough understanding of the present invention. It will be apparent, to one of ordinarily skill in the art, however, that the present invention may be practiced without these specific details. In other instances, well-known methods, procedures, components, and circuits have not been described in detail so as not to unnecessarily obscure aspects of the embodiments.

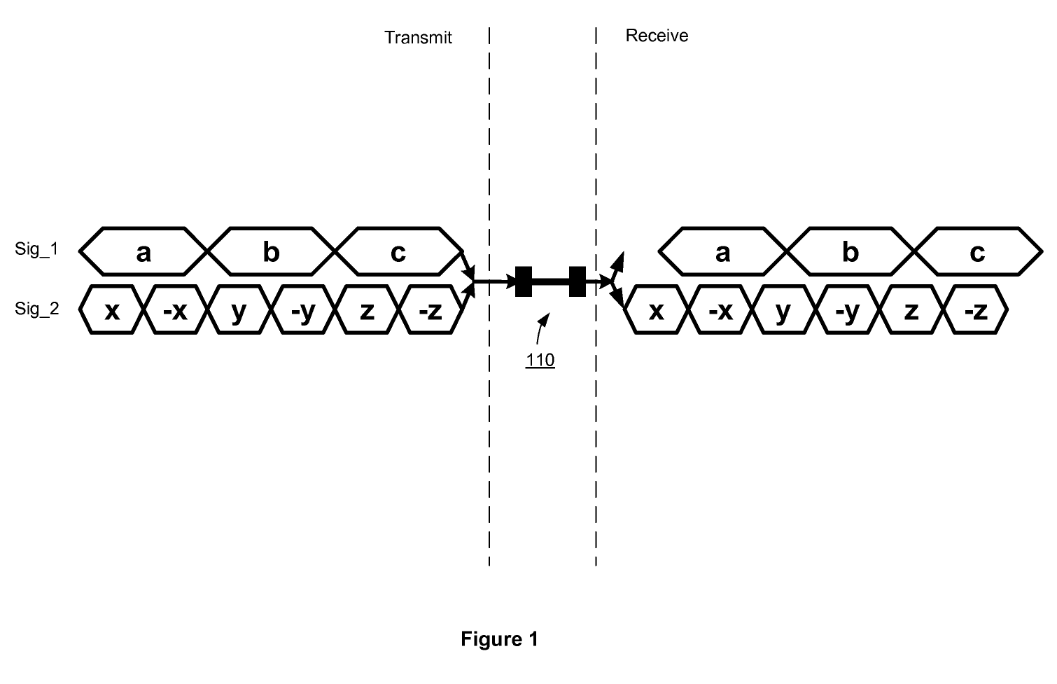

FIG. 1 illustrates an exemplary timing relationship of a data stream in a multi-tone system. A multi-tone system is a set of parallel signals on one physical channel, where individual signals are differentiated by their carrier frequency or frequency band. Channel response, in particular channel latency, is different for each of the parallel signals.

As shown in FIG. 1, a set of orthogonal parallel signals (Sig_1 and Sig_2) are transmitted via channel 110. While only two signals are shown in FIG. 1, the data stream of a multi-tone system may have any number of parallel signals or sub-channels. The multi-tone system of FIG. 1 does not adjust Sig_1 and Sig_2 before transmission, and thus, after transmission through the channel, data symbols in Sig_1 and Sig_2 have become misaligned. Without any adjustment to the individual signals before transmission, the difference in latency between the two sub-channels is not equalized and the signals arrive at the receiver at different times. Embodiments of the present invention equalize latency by adjusting transmit timing of at least one of the parallel signals so that simultaneously transmitted data symbols in the sub-channel signals are substantially aligned when they arrive at the receiver. Stated in another way, embodiments of the present invention equalize latency by adjusting transmit timing of at least one of the parallel signals so that the sub-channel signals are orthogonal, or substantially orthogonal, at the receiver.

In this document, two signals (also herein called substreams), transmitted over different sub-channels of the same physical channel, are substantially aligned in phase when the two signals, upon being sampled at a receiver using the same clock signal, produce received data that meets target performance criteria (e.g., a bit error rate target) for the system. For example, the target performance criteria may be a BER (bit error rate) that is no greater than 10^{-N} (i.e., no more than 1 error per 10^{N} sampled bits or symbols, where N is typically has a value greater than 8). In an alternate embodiment, two signals transmitted over different sub-channels are substantially aligned in phase when the timing mismatch (also called skew) between the signals is, on average, less than ten percent (10%) of the symbol time of the symbols being transmitted by the two signals.

Similarly, the latency differential (or timing mismatch) between two signals (e.g., two substreams) is substantially compensated or substantially equalized when the two signals, upon being sampled at a receiver using the same clock signal, produce received data that meets target performance criteria (e.g., bit error rate target) for the system. Furthermore, a set of three more signals (transmitted over different sub-channels of the same physical channel) are substantially aligned when all of the signals, upon being sampled at a receiver using the same clock signal, produce received data that meets target performance criteria (e.g., bit error rate target) for the system. In addition, a set of sub-channel signals transmitted in parallel over the same physical channel are substantially orthogonal when a receiver can recover the data in the sub-channel signals (e.g., using mixing with a periodic carrier and integration), without having to perform equalization or compensation for inter-channel interference in order to meet target performance criteria (e.g., a bit error rate target).

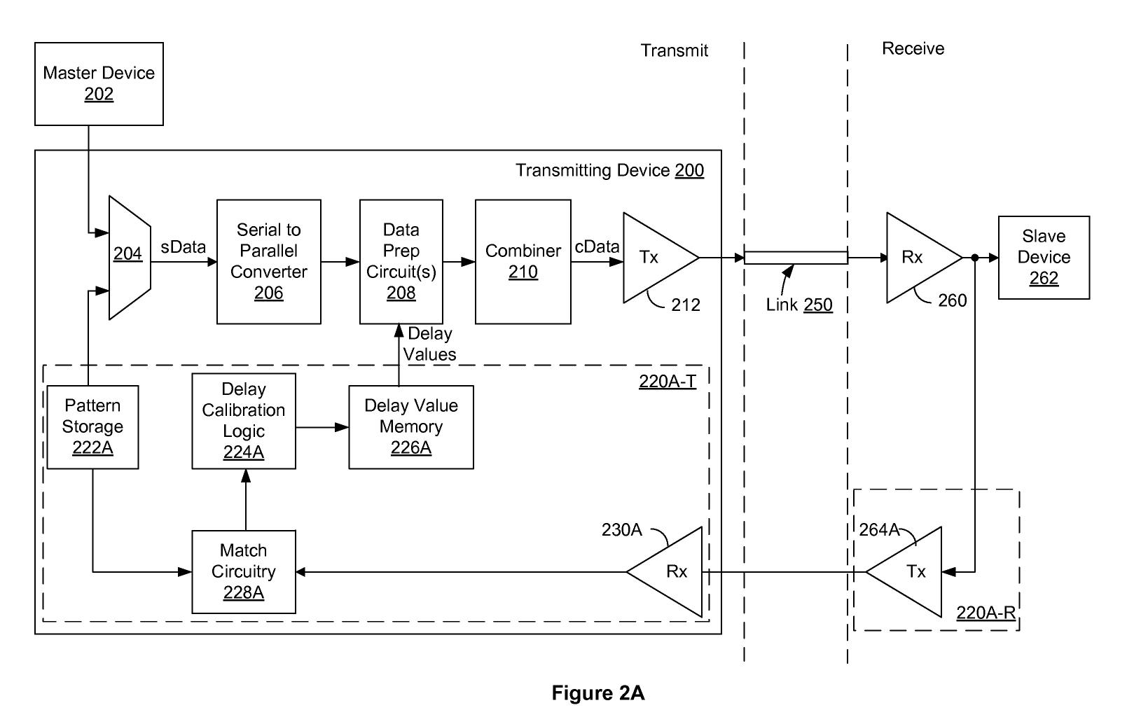

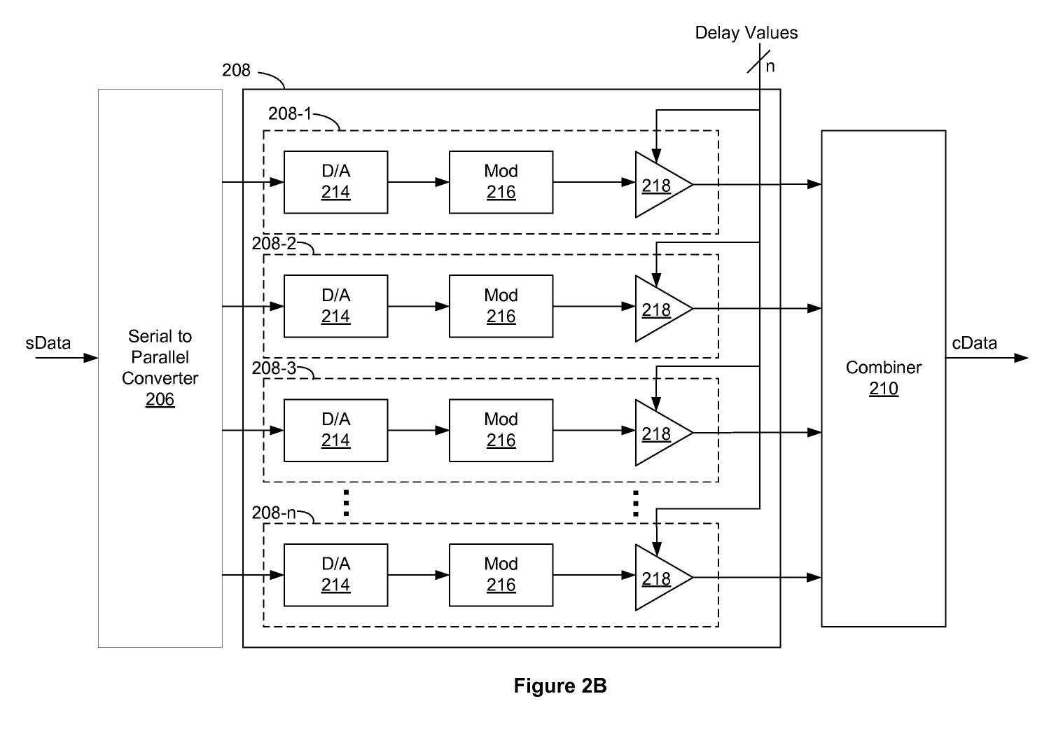

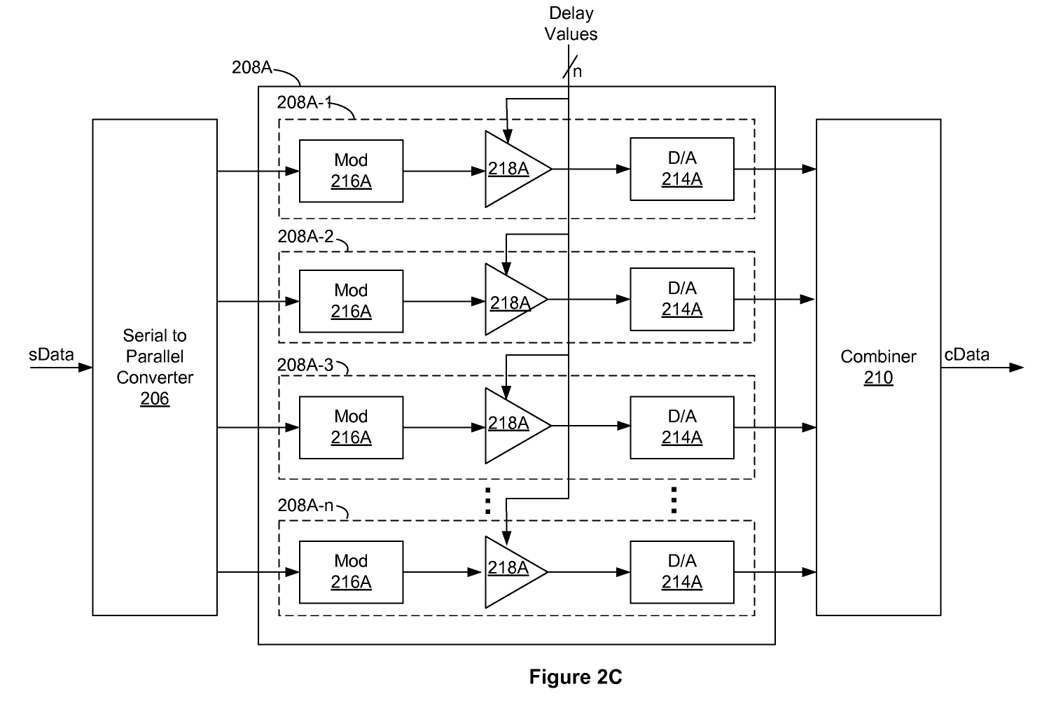

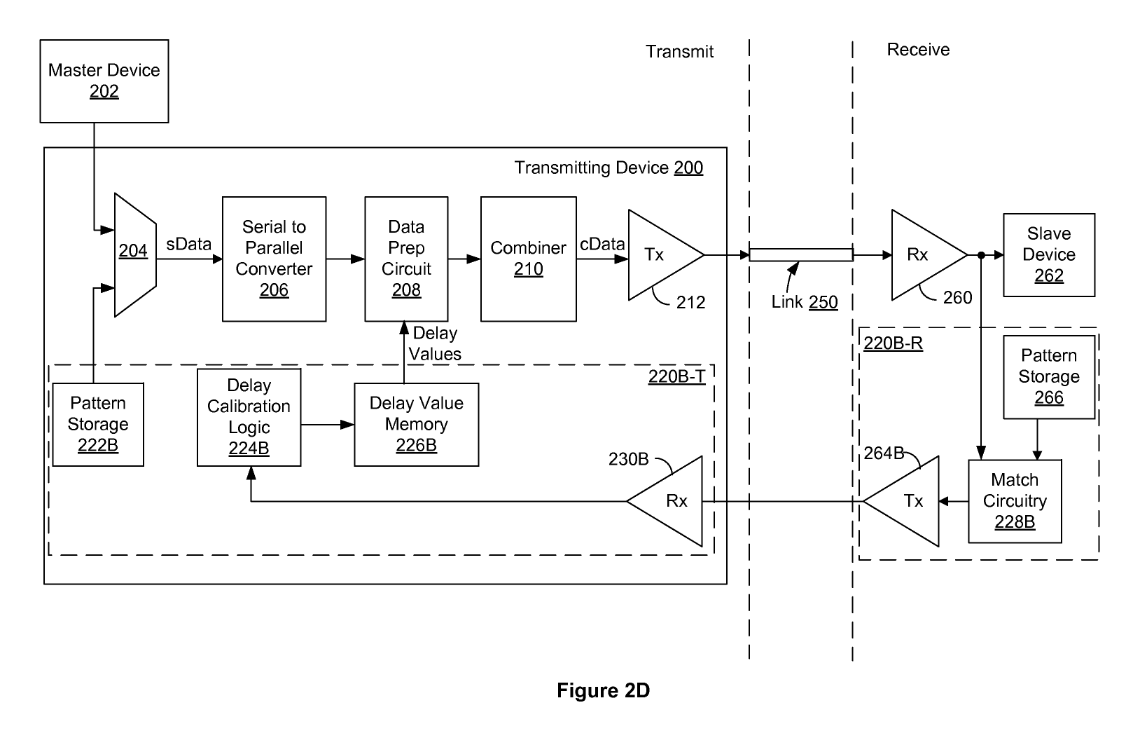

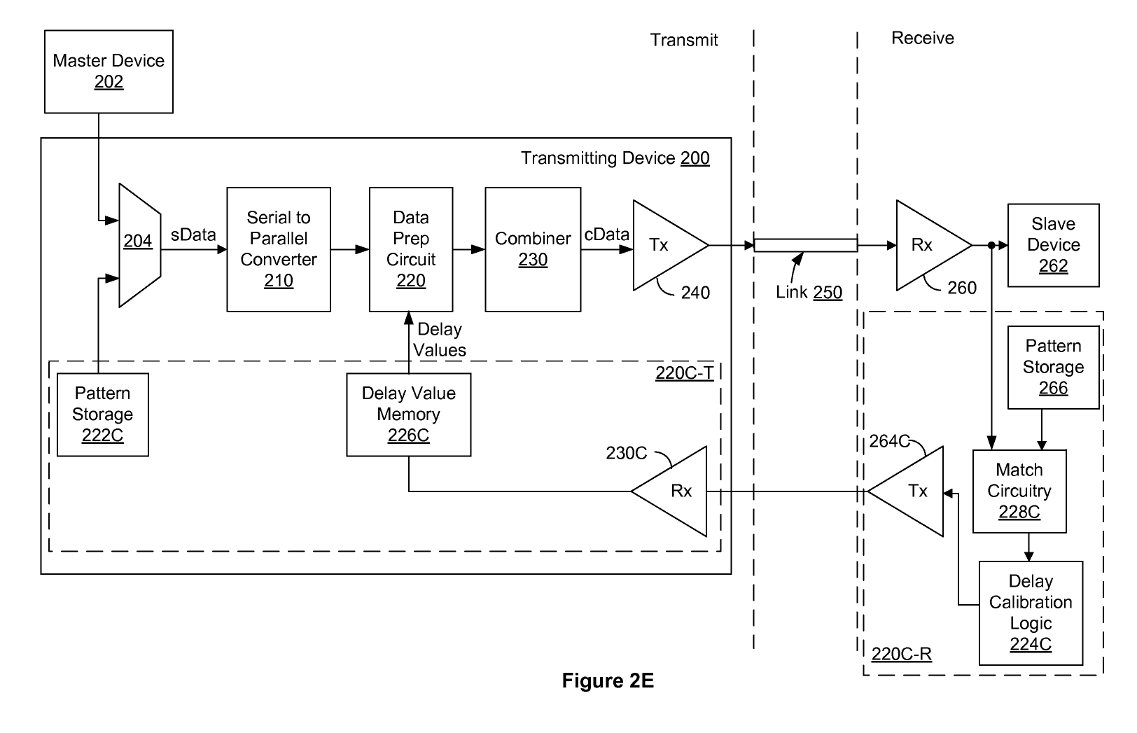

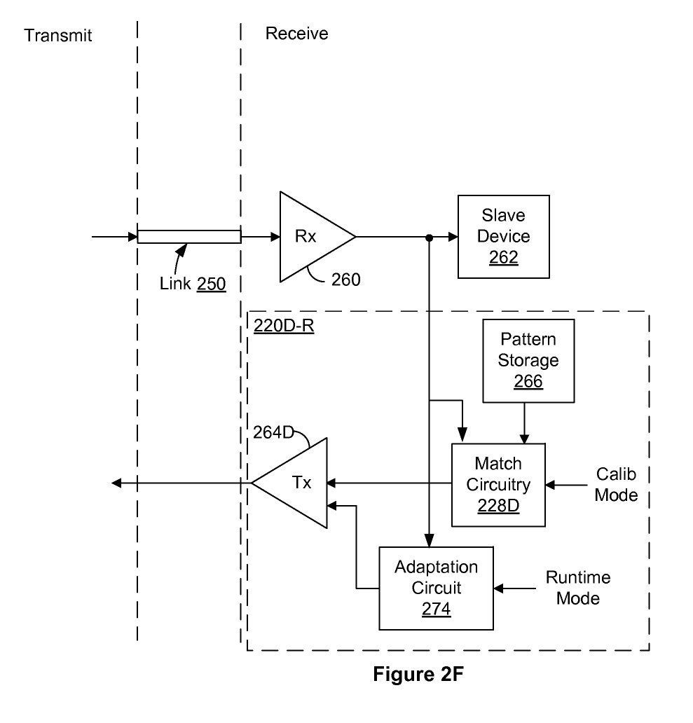

FIG. 2A illustrates a data transmitting device 200 in accordance with some embodiments. As shown in FIG. 2A, the transmitting device 200 includes a multiplexer 204, a serial to parallel converter 206, data preparation circuits 208, a combiner, 210, a transmitter 212, and calibration circuitry 220A-T/220A-R. Data transmitting device 200 prepares a data stream for transmission to a slave device 262 via link 250.

Multiplexer 204 receives a data stream from master device 202 and a pattern signal from the calibration circuitry 220A-T. In some embodiments, master device 202 includes high speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. In some embodiments, master device 202 is or includes a memory controller. In some embodiments, the data transmitting device 200 is incorporated into master device 202.

Serial-to-parallel converter 206 receives a serial data signal (sData) from multiplexer 204 and converts sData into n substreams. Data preparation circuits 208 receive the n substreams from serial-to-parallel converter 206 and also receive a set of delay values from the calibration circuitry 220A-T. In some embodiments, the number of delay values received by the data preparation circuits is n, while in other embodiments the number of delay values received by the data preparation circuits is between 1 and n−1, inclusive. As discussed further below in relation to FIG. 2B, data preparation circuits 208 prepare the n substreams for transmission, which includes delaying a respective substream in accordance with a corresponding delay value to generate a respective sub-channel signal. The delay values are determined by calibration circuitry 220A-T, as described below.

The combiner 210 combines the n sub-channel signals from data preparation circuits 208 to generate a data transmission signal (cData). In some embodiments, the combiner 210 is an adder. In some embodiments, the combiner 210 is a wired-OR circuit. Other equivalent circuits may also be used with equal success. Combiner 210 outputs cData to transmitter 212 for transmission to slave device 262 via link 250 and receiver 260.

As stated above, calibration circuitry 220A-T and 220A-R determines a set of delay values for data preparation circuits 208. The delay values are chosen by comparing the transmitted data stream to the received data stream to identify how link 250 affects each of the sub-channels and, thus, the value that each sub-channel signal should be delayed in order to ensure that the sub-channel signals are orthogonal at the receiver 260. As a practical matter, the delay values for at least n−1 of the n sub-channels are chosen so that data signals simultaneously transmitted over the sub-channels are substantially aligned upon arrival at receiver 260. The delay values are set during an initial calibration process and are maintained by a runtime mode, as discussed further below in relation to FIG. 2F. In some embodiments, the calibration process is performed one sub-channel at a time. In other embodiments, delay values for all of the sub-channels are determined at the same time.

In some embodiments, the calibration circuitry 220A-T/220A-R includes pattern storage 222A, delay calibration logic 224A, delay value memory 226A, match circuitry 228A, and a receiver 230A. A loopback path is formed by intercepting the received data stream as receiver 260 sends it to slave device 262 and transmitting the received data stream to receiver 230A via calibration circuitry 220A-R, which includes transmitter 264A. Pattern storage 222A stores a plurality of calibration patterns and sends a respective calibration pattern to multiplexer 204 for transmission. Match circuitry 228A performs a comparison between the received data stream and the respective calibration pattern, which is received from pattern storage 222A, and produces a match result. Delay calibration logic 224A determines a delay value based on the match result received from match circuitry 228A. As stated above, the delay value is determined such that when the data stream is transmitted, the respective sub-channels will be substantially aligned at the receiver. As a result, the signals received at the receiver are substantially orthogonal. Delay value memory 226A stores the delay values and sends the delay values to the data preparation circuits 208 as needed.

FIG. 2B illustrates data preparation circuits 208 in accordance with some embodiments. As stated above in relation to FIG. 2A, the data preparation circuits 208 receive n substreams from serial-to-parallel converter 206 and n delay values from the calibration circuitry 220A-T/R (FIG. 2A), and output n sub-channel signals to the combiner 210.

In some embodiments, data preparation circuits 208 comprise n parallel data preparation circuits 208-1, 208-2, 208-3 . . . 208-n. Each of the n parallel data preparation circuits 208-1, 208-2, 208-3 . . . 208-n includes a digital-to-analog converter 214, a modulator 216, and a programmable element 218. Digital-to-analog converter 214 converts a corresponding substream from a digital signal to an analog signal and modulator 216 modulates the frequency of the corresponding substream. In some embodiments, the signals output by each modulator 216 has a distinct frequency band (i.e., range of frequencies) that does not overlap the frequency band of the signals output by any of the other modulators 216. As a result, the signals output by the modulators are orthogonal. In other embodiments, the frequency bands of the signals output by the respective modulators overlap, but the signals are preprocessed so that after passing through the communication channel, they can be separated from each other in such a way that each sub-channel meets the target BER without substantial interference from the others.

Programmable element 218 delays a corresponding substream by the corresponding delay value and outputs a respective sub-channel signal to the combiner 210. In some embodiments, programmable element 218 is a filter. In other embodiments, the programmable element 218 is a programmable delay element. Other equivalent circuits may also be used with equal success.

In some embodiments, each of the n parallel data preparation circuits 208-1, 208-2, 208-3 . . . 208-n receives a distinct delay value. In some embodiments, at least two the n parallel data preparation circuits 208-1, 208-2, 208-3 . . . 208-n each receives a first delay value and at least one of the other of the n parallel data preparation circuits 208-1, 208-2, 208-3 . . . 208-n receives a distinct second delay value.

Furthermore, in some embodiments, one or more of the n parallel data preparation circuits 208 does not include a programmable delay element 218. This is because n−1 delay elements is sufficient to compensate for n different sub-channel latencies. In addition, the sub-channel latencies of two (or more) neighboring sub-channels may be substantially the same (e.g., the difference in latencies may be too small, as a practical matter, to impact on the orthogonality of the sub-channel signals at the receiver), thereby further reducing the number of programmable delay elements 218 needed to compensate for differences in the sub-channel latencies.

FIG. 2C illustrates an embodiment of a data preparation circuit 208A. Similar to data preparation circuits 208 (FIG. 2B), data preparation circuits 208A comprise n parallel data preparation circuits 208A-1, 208A-2, 208A-3 . . . 208A-n. Also similar to data preparation circuits 208 (FIG. 2B), each of the n parallel data preparation circuits 208A-1, 208A-2, 208A-3 . . . 208A-n include a modulator 216A, a programmable element 218A, and a digital-to-analog converter 214A. While modulator 216A, programmable element 218A, and digital-to-analog converter 214A perform the same or similar functions as their respective elements in data preparation circuits 208 (FIG. 2B), these elements are in a different order in data preparation circuits 208A. In this regard, a corresponding substream signal is received from serial-to-parallel converter 206 at modulator 216A, programmable element 218A delays the corresponding substream signal, and digital-to-analog circuitry 214A outputs a respective sub-channel signal to combiner 210. In some embodiments, digital-to-analog circuitry 214A is triggered by a clock signal (not shown) that is delayed by another delay element having the same or similar delay as the programmable elements 218A. In other embodiments, digital-to-analog circuitry 214A is not triggered by a clock signal.

In these embodiments the modulator 216 operates in the digital domain, modulating digital data signals. In one embodiment, the substream received at each modulator 216 is multiplied by a distinct Hadamard code, which makes the substreams orthogonal so long as they are received in parallel with substantially the same latency.

FIG. 2D illustrates calibration circuitry 220B-T/220B-R in accordance with some embodiments. While calibration circuitry 220B-T/220B-R functions in the same manner as calibration circuitry 220A-T/220A-R, the location of the complementary elements is different in calibration circuitry 220B-T/220B-R. Calibration circuitry 220B-T includes pattern storage 222B, delay calibration logic 224B, delay value memory 226B, and a receiver 230B. Calibration circuitry 220B-R includes pattern storage 266 and match circuitry 228B. Pattern storage 222B and pattern storage 266 store the same calibration patterns. Match circuitry 228B is configured to produce a match result and transmit the match result to delay calibration logic 224B via transmitter 264B and receiver 230B.

FIG. 2E illustrates calibration circuitry 220C-T/220C-R in accordance with some embodiments. While calibration circuitry 220C-T/220C-R functions in the same manner as calibration circuitry 220A-T/220A-R, the location of the complementary elements is different in calibration circuitry 220C-T/220C-R. Calibration circuitry 220C-T includes pattern storage 222C, delay value memory 226C, and a receiver 230C. Calibration circuitry 220C-R includes pattern storage 266, match circuitry 228C, and delay calibration logic 224C. Pattern storage 222C and pattern storage 266 store the same calibration patterns. Delay calibration logic 224C produces delay values from the match result, which is produced by match circuitry 228C, and transmits the delay values to delay value memory 226C via transmitter 264C and receiver 230C.

Referring to FIG. 2F, in some embodiments the calibration circuitry 220D-R includes an adaptation circuit 274, as well as pattern storage 266, match circuitry 228D and transmitter 264D. These embodiments of the receive-side calibration circuitry 220D-R can be used in place of any of the receive-side calibration circuits 220A-R (FIG. 2A), 220B-R (FIG. 2D) or 220C-R (FIG. 2E) described above. As stated above, the delay values are set during an initial calibration process and are maintained by a runtime mode calibration process. Only one of the modes, calibration or runtime, is operative at any one time.

In the embodiments represented by FIG. 2F, match circuitry 228D is enabled when it receives a calibration mode signal (Calib Mode). The calibration mode signal enables the initial calibration process, which sets initial delay values for the sub-channels. In calibration mode, the initial calibration process transmits one or more patterns from pattern storage 222 (e.g., 222A, 222B or 222C) in the transmitting device to the receiving device. Match circuitry 228D performs a comparison between the received data stream and the respective calibration pattern, which is received from pattern storage 266, and produces a match result.

Adaptation circuit 274 receives a runtime mode signal (Runtime Mode) to enable the runtime mode calibration process, which provides fine adjustments to the delay values. Stated another way, the adaptation circuit 274 is enabled by the runtime mode signal, which is activated only during the runtime mode. When enabled, the adaptation circuit 274 determines adjustments to the previously established delay values so as to compensate for any changes in the relative latencies of the sub-channels over which the substreams of data are being transmitted, thereby keeping the substreams orthogonal. The adjustments are transmitted by transmitter 264D to the transmitting device 200, which updates the delay values. The runtime mode calibration process runs in the background, without interrupting the transmission of data from the master device 202 (FIG. 2A) to the slave device 262 via the transmitting device 200 and the link 250.

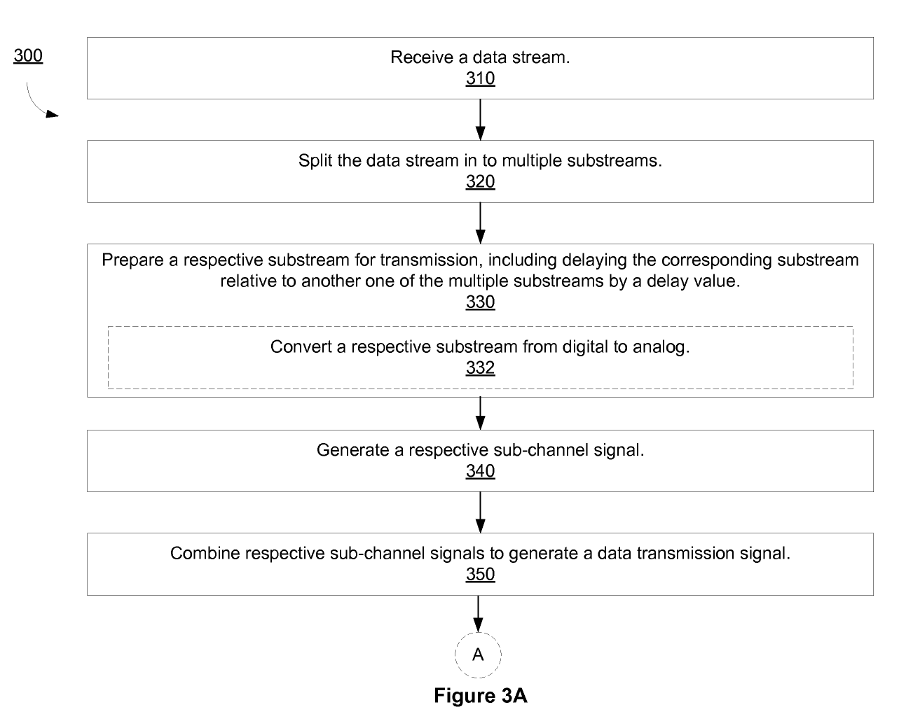

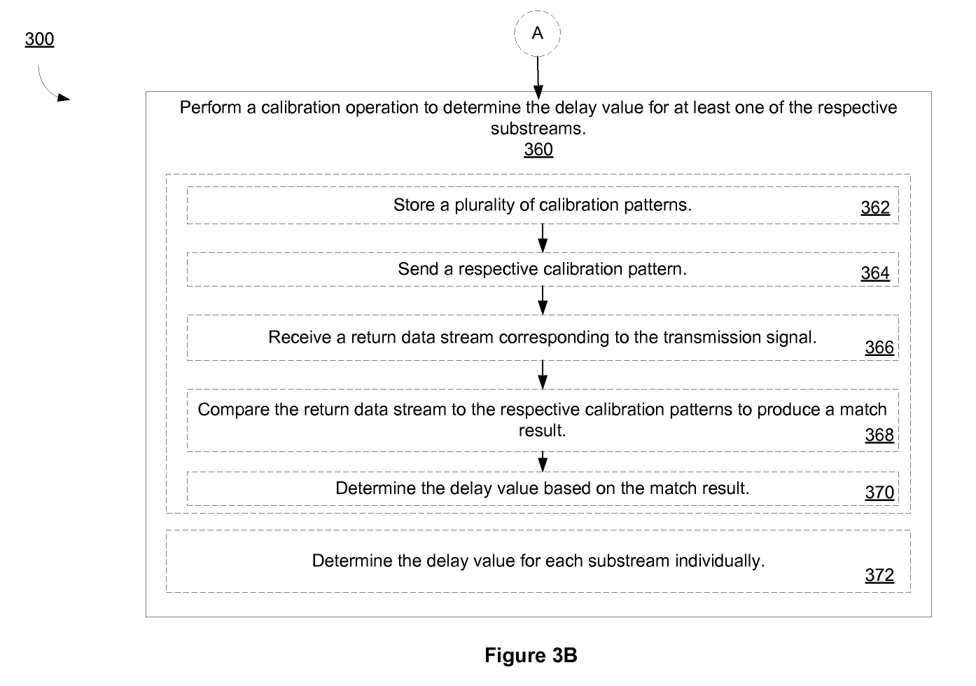

FIGS. 3A-B are flow diagrams illustrating a process 300 of transmitting data in accordance with some embodiments. Process 300 can be performed using one or more of the transmitting and receiving devices described above with reference to FIGS. 2A-2F. As shown in FIG. 3A, the process 300 includes receiving a data stream 310 (e.g., from another device, or from another portion of the device that is performing the process 300) and splitting the data stream in to multiple substreams 320.

A respective substream is prepared for transmission, which includes delaying the corresponding substream relative to another one of the multiple substreams by a delay value 330. In some embodiments, a respective substream is converted from digital to analog 332.

The process 300 further includes generating a respective sub-channel signal 340 and combining respective sub-channel signals to generate a data transmission signal 350. The data transmission signal is transmitted over a link or other physical channel to a receiving device.

In some embodiments, and as shown in FIG. 3B, the process 300 may further include performing a calibration operation to determine the delay value for at least one of the respective substreams 360. In some embodiments, the calibration operation includes storing a plurality of calibration patterns 362, sending a respective calibration pattern 364, receiving a return data stream corresponding to the transmission signal 366, comparing the return data stream to one or more of the respective calibration patterns to produce a match result 368, and determining the delay value based on the match result 370. In some embodiments, the delay value for each substream is determined individually 372. Alternately, as described above, distinct delay values are determined for only a subset of the substreams. Furthermore, in some embodiments, the receiving device compares data recovered from the received transmission signal with one or more calibration patterns, in place of operations 364, 366 and 368.

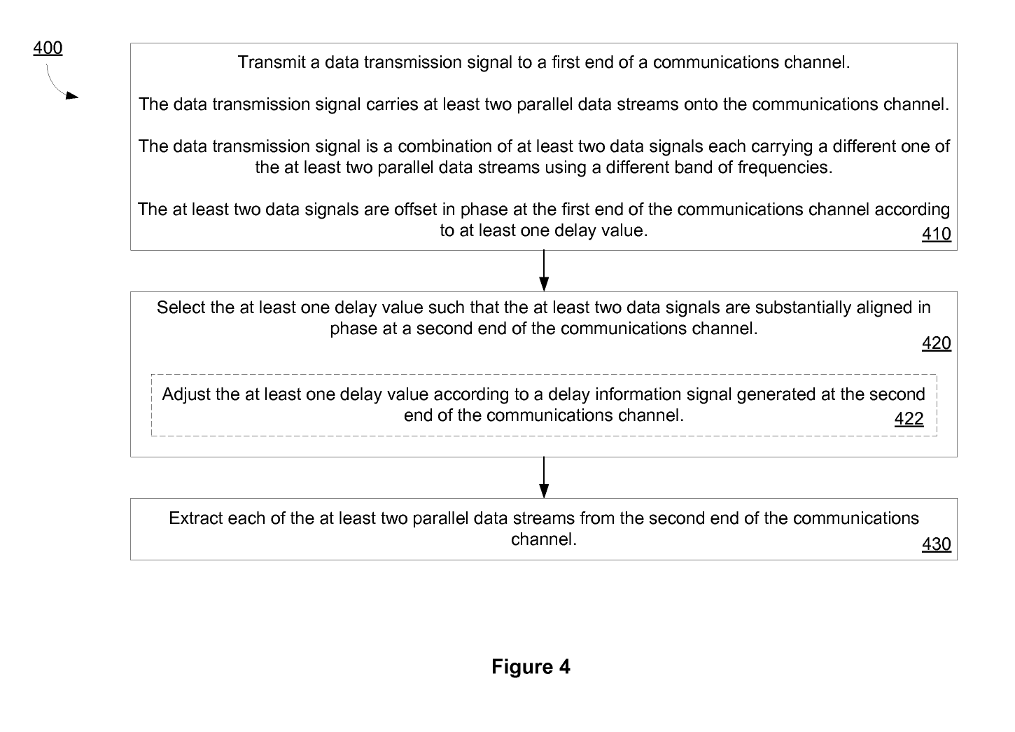

FIG. 4 is flow diagram illustrating a process 400 of transmitting data in accordance with some embodiments. Process 400 can be performed using one or more of the transmitting and receiving devices described above with reference to FIGS. 2A-2F. The process 400 includes transmitting a data transmission signal to a first end of a communication channel 410. The data transmission signal carries at least two parallel data streams onto the communication channel. In some embodiments, the data transmission signal is a combination of at least two data signals, each data signal carrying a different one of the at least two parallel data streams using a different band of frequencies. Further, the at least two data signals are offset in phase with respect to each other at the first end of the communications channel according to at least one delay value.

The process 400 further includes selecting the at least one delay value such that the at least two data signals are substantially aligned in phase at a second end of the communications channel 420. In some embodiments, the at least one delay value is adjusted according to a delay information signal generated at the second end of the communications channel 422.

The process 400 also includes extracting each of the at least two parallel data streams from the second end of the communications channel 430.

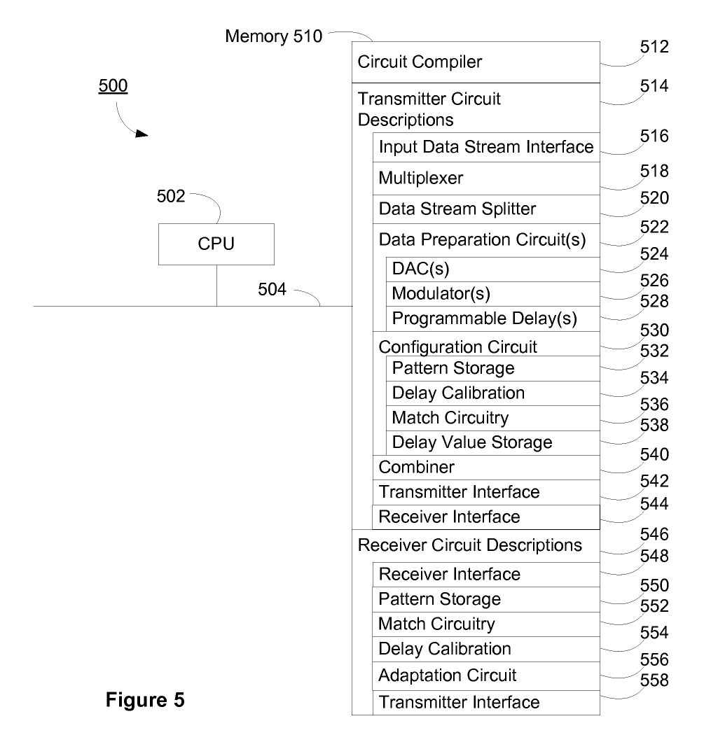

FIG. 5 is a block diagram illustrating a system 500 for storing computer readable files containing data representing a data transmission circuit in accordance with at least one embodiment of the present invention. The system 500 typically includes one or more processing units (CPU's) 502, memory 510, and one or more communication buses 504 for interconnecting these components. Memory 510 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 510 may optionally include one or more storage devices remotely located from the CPU(s) 502. Memory 510, or alternately the non-volatile memory device(s) within memory 510, comprises a computer readable storage medium.

In some embodiments, memory 510, or the computer readable storage medium of memory 510, stores a circuit compiler 512, transmitter circuit descriptions 514, and receiver circuit descriptions 546. The circuit compiler 512, when executed by a processor such as CPU 502, processes one or more circuit descriptions to synthesize one or more corresponding circuits. The transmitter circuit descriptions 514 correspond to the transmitter circuits embodiments described above. The receiver circuit descriptions 546 correspond to the receiver circuits embodiments described above.

In some embodiments, the transmitter circuit descriptions 514 include input data stream interface descriptions 516, multiplexer descriptions 518, data stream splitter descriptions 520, one or more data preparation circuit descriptions 522, configuration circuit descriptions 530, combiner description 540, transmitter interface descriptions 542, and receiver interface descriptions 544. In some embodiments, the one or more data preparation circuit descriptions 522 include one or more digital-to-analog converter descriptions 524, one or more modulator descriptions 526, and one or more programmable delay descriptions 528. In some embodiments, the configuration circuit descriptions 530 include pattern storage 532, delay calibration descriptions 534, match circuitry descriptions 536, and delay value storage 538.

In some embodiments, the receiver circuit descriptions 546 include receiver interface descriptions 548, pattern storage 550, match circuitry descriptions 552, delay calibration descriptions 554, adaptation circuit descriptions 556, and transmitter interface descriptions 558.

The above identified modules or programs (i.e., sets of instructions) need not be implemented as separate software programs, procedures or modules, and thus various subsets of these modules may be combined or otherwise re-arranged in various embodiments. In some embodiments, memory 510 may store a subset of the modules and data structures identified above. Furthermore, memory 510 may store additional modules and data structures not described above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A data transmission circuit, comprising:
an interface to receive a data stream for transmission;
a data stream splitter to split the data stream to produce multiple substreams;
a plurality of parallel data preparation circuits, each data preparation circuit to prepare a corresponding substream for transmission and to generate a respective sub-channel signal;
wherein at least two of the data preparation circuits each comprises a programmable element to receive a respective delay value and to delay the corresponding substream in accordance with the respective delay value; and
a combiner to combine the respective sub-channel signals to generate a data transmission signal.

2. The data transmission circuit of claim 1, wherein each programmable element is to receive a distinct delay value.

3. The data transmission circuit of claim 1, wherein at least two of the plurality of programmable elements are to receive a first delay value and at least one other of the plurality of programmable elements is to receive a second delay value.

4. The data transmission circuit of claim 1, wherein each data preparation circuit comprises a modulator for frequency conversion of the corresponding substream.

5. The data transmission circuit of claim 1, wherein each data preparation circuit comprises a digital to analog conversion circuit.

6. The data transmission circuit of claim 1, further comprising calibration circuitry to calibrate the plurality of data preparation circuits.

7. The data transmission circuit of claim 6, wherein the calibration circuitry comprises:
pattern storage to store a plurality of calibration patterns and send a respective calibration pattern to the data stream splitter;
a match circuit to receive a return data stream corresponding to the transmission signal and compare the return data stream to the respective calibration pattern to produce a match result; and
delay calibration logic to determine a delay value based on the match result.

8. The data transmission circuit of claim 6, wherein each of the plurality of data preparation circuits is to be calibrated individually.

9. The data transmission circuit of claim 1, wherein each programmable element comprises a programmable filter circuit.

10. A method of transmitting data, comprising:
receiving a data stream for transmission;
splitting the data stream to produce multiple substreams at a data stream splitter;
preparing the multiple substreams for transmission, wherein the preparing comprises, for each of at least two respective substreams, receiving a respective delay value and delaying the respective substream in accordance with the respective delay value;
generating respective sub-channel signals from the multiple substreams; and
combining the respective sub-channel signals to generate a data transmission signal.

11. The method of claim 10, wherein the preparing comprises converting the respective substream from a digital signal to an analog signal.

12. The method of claim 10, further comprising performing a calibration operation to determine the respective delay value for at least one of the multiple substreams.

13. The method of claim 12, wherein performing the calibration operation comprises:
storing a plurality of calibration patterns;
sending a respective calibration pattern to the data stream splitter;
receiving a return data stream corresponding to the data transmission signal;
comparing the return data stream to the respective calibration pattern to produce a match result; and
determining the respective delay value based on the match result.

14. The method of claim 12, wherein performing the calibration operation comprises determining the respective delay value for each substream individually.

15. A data communications system, comprising:
a communications channel;
a data transmission circuit at a first end of the communications channel, the data transmission circuit to output a data transmission signal carrying at least two parallel data streams onto the communications channel, the data transmission signal being a combination of at least two data signals each carrying a different one of the at least two parallel data streams using a different frequency band, the at least two data signals being offset in phase at the first end of the communications channel and being substantially aligned in phase at a second end of the communications channel; and
a data receiving circuit at the second end of the communication channel, the data receiving circuit to extract each of the at least two parallel data streams from the data transmission signal;
wherein the data transmission circuit is to offset at least two data signals in phase according to at least one delay value.

16. The data communications system of claim 15, wherein the data receiving circuit is configured to transmit a delay information signal to the data transmission circuit, and wherein the data transmission circuit is configured to adjust the at least one delay value according to the delay information signal.

17. The data communications system of claim 15, wherein the at least two data signals comprise three data signals, the data transmission circuit to offset in phase the three data signals according to at least two delay values, wherein the data receiving circuit is configured to transmit a delay information signal to the data transmission circuit, and wherein the data transmission circuit is configured to adjust the at least two delay values according to the delay information signal.

18. A method of transmitting data, comprising:
transmitting a data transmission signal at a first end of a communications channel, wherein the data transmission signal carries at least two parallel data streams onto the communications channel, the data transmission signal being a combination of at least two data signals each carrying a different one of the at least two parallel data streams using a different band of frequencies, the at least two data signals being offset in phase at the first end of the communications channel according to at least one delay value;
selecting the at least one delay value such that the at least two data signals are substantially aligned in phase at a second end of the communications channel; and
extracting each of the at least two parallel data streams from the second end of the communications channel.

19. The method of claim 18, further comprising:
adjusting the at least one delay value according to a delay information signal generated at the second end of the communication channel.

20. A multi-tone device, comprising:
at least one data pin to be coupled to a first end of a first communications channel;
a data transmission circuit coupled to the at least one data pin, the data transmission circuit to output a data transmission signal carrying at least two parallel data streams onto the first communications channel, the data transmission signal being a combination of at least two data signals each carrying a different one of the at least two parallel data streams using a different band of frequencies, the at least two data signals being offset in phase at the first end of the first communications channel according to at least one delay value, the at least one delay value being selected such that the at least two data signals are substantially aligned in phase at a second end of the first communications channel.

21. The multi-tone device of claim 20, further comprising a signal receiving circuit to receive a delay information signal from a second communications channel and to adjust the at least one delay value according to the delay information signal.

22. The multi-tone device of claim 21, wherein the first and second communications channels share at least one signal wire.

23. The multi-tone device of claim 20, wherein the data transmission signal is a differential signal and the at least one signal pin includes a pair of signal pins.
